(19) United States
(12) Patent Application Publication
(10) Pub. No.: US 2007/0262273 A1
(43) Pub. Date: Nov. 15, 2007

(54) Drug counter

(76) Inventors: Tzam-Fu Sun, Kaohsiung City (TW); Wen-Cheng Wu, Kaohsiung Hsien (TW)

Correspondence Address: TZAM-FU SUN, 235 Chung - Ho, Box 8-24, Taipei, R.O.C., TW

(21) Appl. No.: 11/433,867

(22) Filed: May 15, 2006

(51) Int. Cl. G21F 5/00

(52) U.S. Cl. 250/507.1

(57) ABSTRACT

A drug counter comprises a body having an upper utensil and a lower utensil; a surface of the upper utensil having a plurality of drug holes; one side of the lower utensil having an opening for receiving the sliding plate; a sliding plate being insertable into the lower utensil from the opening at one side of the body; the sliding plate resisting against a lower side of the drug holes of the upper utensil. In use, the drugs are placed upon a surface of the upper utensil. The surplus drugs are driven to the upper utensil. The sliding plate can be driven to move according to the amount of the drugs so that the drugs in the drug holes fall into the lower utensil. The drugs falling into the lower utensil further fall into the drug bag so as to count the number of the drugs.

### FIELD OF THE INVENTION

The present invention relates to drug counters, and in particular to a drug counter which can quickly and precisely count the drug particles (such as capsules or tablets).

### BACKGROUND OF THE INVENTION

Currently, in hospitals or clinics, the drugs are poured out from a bottle to a utensil. The drugs are concentrated at one side of the utensil. Then a drug spoon is used to move the drugs to another side of the utensil. Then the drugs having the required number are filled into a drug bag so as to have drugs with required number.

Above-mentioned drug counting process is completed manually. The speed is low and it is very easily to have errors due to external interruptions. This is especially in a state of giving drugs to chronic disease.

### SUMMARY OF THE INVENTION

Accordingly, the primary object of the present invention is to provide a drug counter which can quickly and precisely count the drug particles (such as capsules or tablets).

To achieve above objects, the present invention provides a drug counter which comprises a body having an upper utensil and a lower utensil; a surface of the upper utensil having a plurality of drug holes; one side of the lower utensil having an opening for receiving the sliding plate; a sliding plate being insertable into the lower utensil from the opening at one side of the body; the sliding plate resisting against a lower side of the drug holes of the upper utensil. In use, the drugs are placed upon a surface, of the upper utensil. The surplus drugs are driven to the upper utensil. The sliding plate can be driven to move according to the amount of the drugs so that the drugs in the drug holes fall into the lower utensil. The drugs falling into the lower utensil further fall into the drug bag so as to count the number of the drugs.

The various objects and advantages of the present invention will be more readily understood from the following detailed description when read in conjunction with the appended drawing.

### BRIEF DESCRIPTION OF THE DRAWINGS

FIG. 1 is an exploded perspective view of the present invention.

FIG. 2 is an assembled perspective view of the present invention.

FIG. 3 is an elevational view of the present invention.

FIG. 4 is a cross sectional view of the present invention along line I-I of FIG. 3.

FIG. 5 shows one application of the present invention, wherein the drugs fall into the upper utensil, and surplus drugs fall into drug holes from the drug output.

FIG. 6 shows another application of the present invention, where the operation of drugs falling into the drug holes is illustrated.

FIG. 7 is a schematic cross sectional view about the operation of the sliding plate according to the number of the drugs to be given.

FIG. 8 shows that the drugs on the lower utensil fall to the drug bag.

FIG. 9 is a schematic view showing that the shape of the drug hole is a round shape.

### DETAILED DESCRIPTION OF THE INVENTION

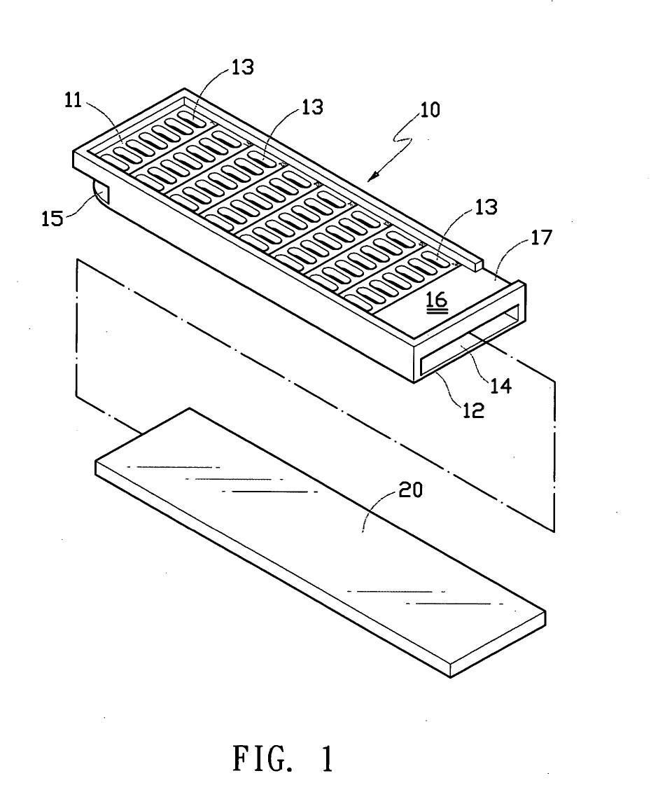

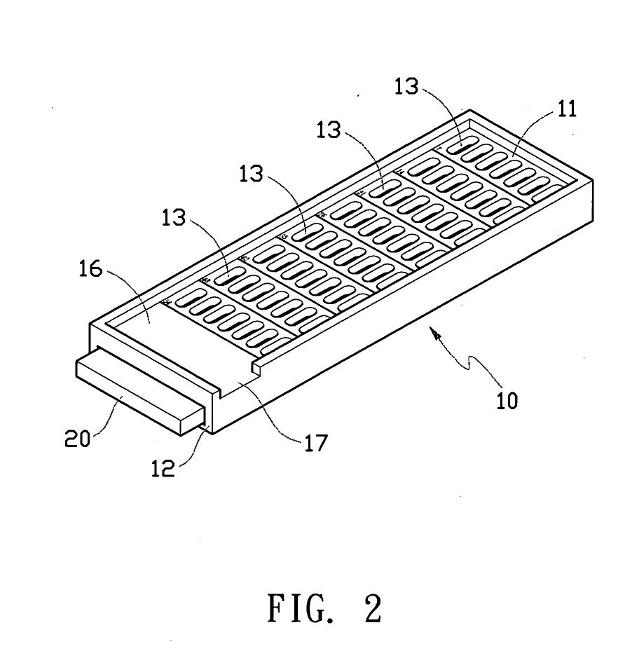

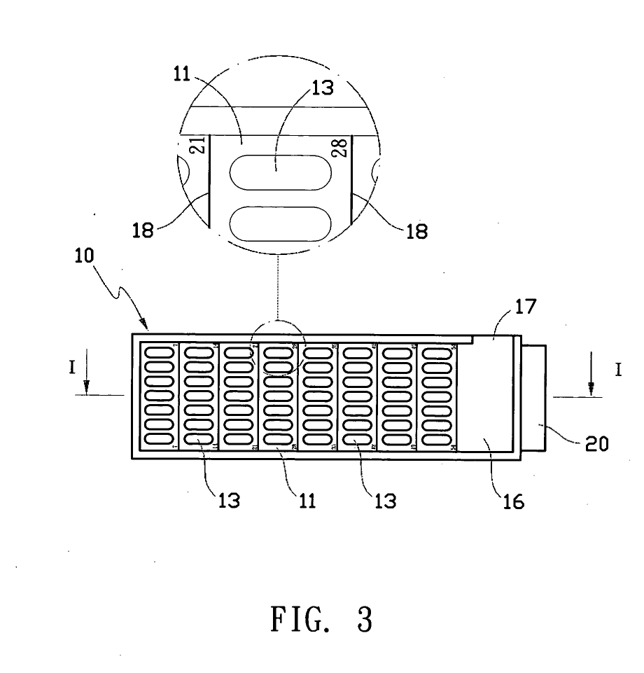

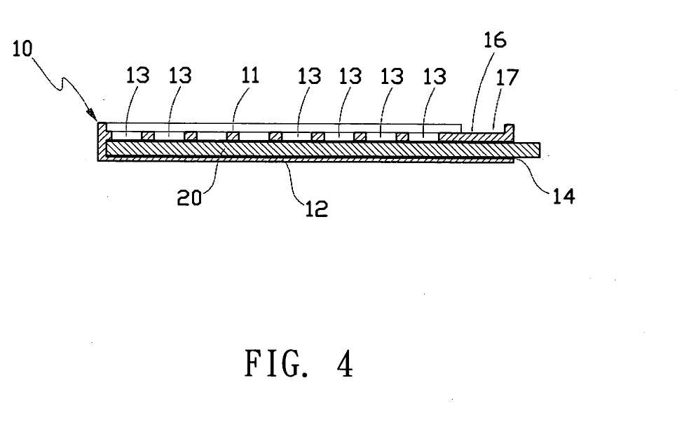

In order that those skilled in the art can further understand the present invention, a description will be provided in the following in details. However, these descriptions and the appended drawings are only used to cause those skilled in the art to understand the objects, features, and characteristics of the present invention, but not to be used to confine the scope and spirit of the present invention defined in the appended claims. Referring to FIGS. 1 to 7, the present invention is illustrated. The present invention has the following elements.

Referring to FIG. 1, the present invention includes a body 10 and a sliding plate 20.

With reference to FIGS. 1, 2, 3, and 4, the body 10 of the present invention has an upper utensil 11 and a lower utensil 12. A surface of the upper utensil 11 has a plurality of drug holes 13. One side of the lower utensil 12 has an opening 14 for receiving the sliding plate 20. A corner of another end opposite the end having the opening 14 has a drug outlet 15.

The sliding plate 20 (see FIGS. 1, to 4) is insertable into the lower utensil 12 from the opening 14 at one side of the body 10. The sliding plate 20 resists against the lower side of the drug holes 13 of the upper utensil 11.

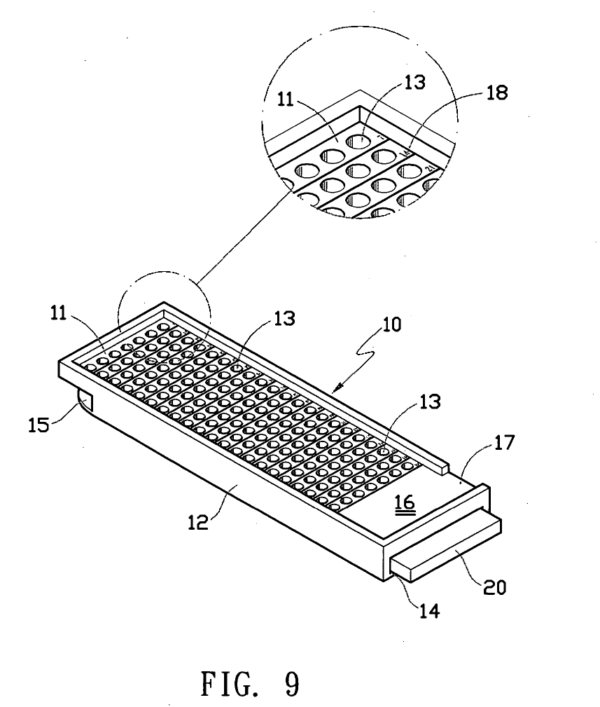

The shape of each drug hole 13 is a long hole like the shape of a drug capsule (referring to FIGS. 1 to 4) or a round hole (referring to FIG. 9) as the shape of a tablet or other shapes. The size of each drug hole 13 is exactly to pass the drug 30.

Further, referring to FIGS. 1 to 4, preferably, one end of the upper utensil 11 has a platform 16. One corner of the platform 16 is a drug outlet 17.

Further, referring to FIGS. 1 to 4, preferably, the drug holes 13 are arranged in order longitudinally and transversally. Preferably, each line has seven drug holes 13.

Moreover referring to FIGS. 1 to 3, preferably, the upper utensil 11 of the body 10 is formed with scales 18 corresponding to the drug holes 13.

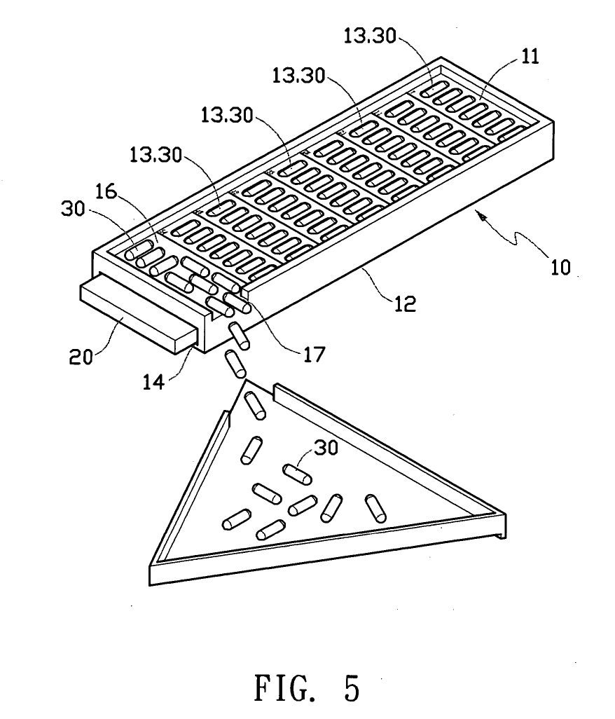

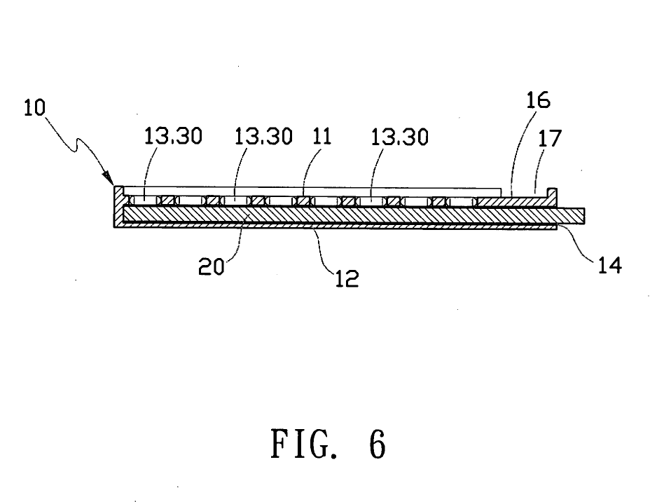

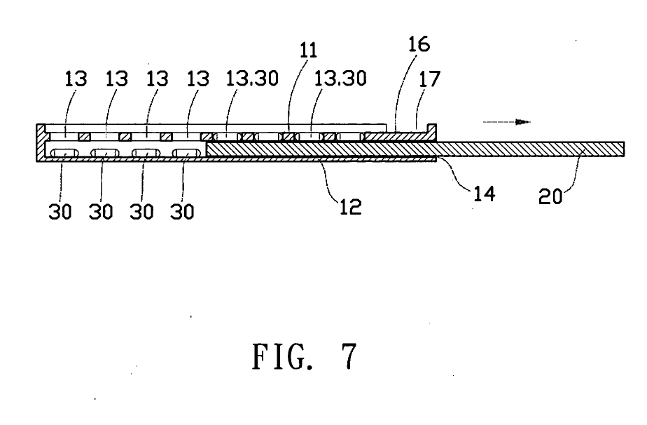

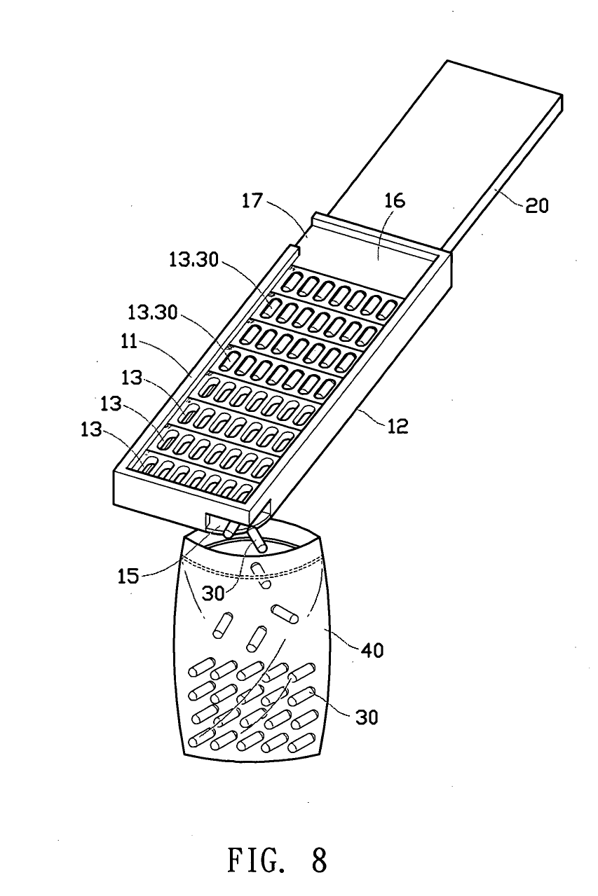

Referring to FIGS. 5 to 6, in use of the present invention, the drugs 30 are placed upon the surface of the upper utensil 11. Then the body 10 is shaken so that the drugs 30 fall into drug holes 13 or the drugs 30 are driven by a drug spoon (not shown) to fall into the drug holes 13. The surplus drugs 30 are driven to the platform 16 of the upper utensil 11. Then the drugs 30 are outputted to the upper utensil 11 from one corner of the platform 16. Then, as shown in FIG. 7, the sliding plate 20 can be driven to move according to the amount of the drugs so that the drugs 30 in the drug holes 13 fall into the lower utensil 12. Next, as shown in FIG. 8, the drugs falls into the lower utensil 12 from the drug outlet 15 and then into the drug bag 40 so as to count the number of the drugs.

Thus, from above described, it is known that the present invention can quickly and precisely count the drug particles with an effect better than the prior art.

The present invention is thus described, it will be obvious that the same may be varied in many ways. Such variations are not to be regarded as a departure from the spirit and scope of the present invention, and all such modifications as would be obvious to one skilled in the art are intended to be included within the scope of the following claims.

What is claimed is:

1. A drug counter comprising
a body having an upper utensil and a lower utensil; a surface of the upper utensil having a plurality of drug holes; one side of the lower utensil having an opening for receiving the sliding plate;
a sliding plate being insertable into the lower utensil from the opening at one side of the body; the sliding plate resisting against a lower side of the drug holes of the upper utensil;
wherein in use, the drugs are placed upon a surface of the upper utensil; sliding plate is driven to move according to the amount of the drugs so that the drugs in the drug holes fall into the lower utensil; the drugs falling into the lower utensil further fall into the drug bag so as to count the number of the drugs.

2. The drug counter as claimed in claim 1, wherein a shape of each drug hole is one of a long hole and a round hole.

3. The drug counter as claimed in claim 1, wherein a size of the drug hole is exactly passed through by one drug.

4. The drug counter as claimed in claim 1, wherein one end of the upper utensil has a platform.

5. The drug counter as claimed in claim 1, wherein a corner of another end opposite the end having the opening is formed with a drug outlet.

6. The drug counter as claimed in claim 1, wherein the drug holes are arranged in order longitudinally and transversally.

7. The drug counter as claimed in claim 1, wherein each line has seven drug holes.

8. The drug counter as claimed in claim 1, wherein the upper utensil has scales corresponding to the positions of the drug holes.
